(19) United States
(12) Patent Application Publication
(10) Pub. No.: US 2018/0287690 A1
(43) Pub. Date: Oct. 4, 2018

(54) SIGNAL BOOSTER WITH ACTIVE AND PASSIVE SIGNAL PATHS

(71) Applicant: WILSON ELECTRONICS, LLC, St. George, UT (US)

(72) Inventors: Christopher Ken Ashworth, St. George, UT (US); Stephen Todd Fariss, Frisco, TX (US); Jeffrey Thomas Gudewicz, Parker, CO (US)

(21) Appl. No.: 15/945,625

(22) Filed: Apr. 4, 2018

Related U.S. Application Data
(60) Provisional application No. 62/481,414, filed on Apr. 4, 2017.

(51) Int. Cl. H04B 7/155

(52) U.S. Cl. CPC H04B 7/15535; H04B 7/15542

(57) ABSTRACT

Technology for a signal booster is disclosed. The signal booster can include one or more active signal paths configured to filter and amplify signals in one or more bands. The signal booster can include a passive signal path adjacent to the one or more active signal paths. The passive signal path can be configured to passively pass through signals in one or more bands without amplification of the signals.

### RELATED APPLICATIONS

The present application claims priority to U.S. Provisional Patent Application No. 62/481,414, filed Apr. 4, 2017 with a docket number of 3969-115.PROV, the entire specification of which is hereby incorporated by reference in its entirety for all purposes.

### BACKGROUND

Signal boosters and repeaters can be used to increase the quality of wireless communication between a wireless device and a wireless communication access point, such as a cell tower. Signal boosters can improve the quality of the wireless communication by amplifying, filtering, and/or applying other processing techniques to uplink and downlink signals communicated between the wireless device and the wireless communication access point.

As an example, the signal booster can receive, via an antenna, downlink signals from the wireless communication access point. The signal booster can amplify the downlink signal and then provide an amplified downlink signal to the wireless device. In other words, the signal booster can act as a relay between the wireless device and the wireless communication access point. As a result, the wireless device can receive a stronger signal from the wireless communication access point. Similarly, uplink signals from the wireless device (e.g., telephone calls and other data) can be directed to the signal booster. The signal booster can amplify the uplink signals before communicating, via an antenna, the uplink signals to the wireless communication access point.

### BRIEF DESCRIPTION OF THE DRAWINGS

Features and advantages of the disclosure will be apparent from the detailed description which follows, taken in conjunction with the accompanying drawings, which together illustrate, by way of example, features of the disclosure; and, wherein:

FIG. 1 illustrates a signal booster in communication with a wireless device and a base station in accordance with an example;

FIG. 2 illustrates a cellular signal booster configured to amplify uplink (UL) and downlink (DL) signals using one or more downlink signal paths and one or more uplink signal paths in accordance with an example;

FIG. 3 illustrates a signal booster with one or more active signal paths and an adjacent passive signal path in accordance with an example; and

FIG. 4 illustrates a wireless device in accordance with an example.

Reference will now be made to the exemplary embodiments illustrated, and specific language will be used herein to describe the same. It will nevertheless be understood that no limitation of the scope of the invention is thereby intended.

### DETAILED DESCRIPTION

Before the present invention is disclosed and described, it is to be understood that this invention is not limited to the particular structures, process steps, or materials disclosed herein, but is extended to equivalents thereof as would be recognized by those ordinarily skilled in the relevant arts. It should also be understood that terminology employed herein is used for the purpose of describing particular examples only and is not intended to be limiting. The same reference numerals in different drawings represent the same element. Numbers provided in flow charts and processes are provided for clarity in illustrating steps and operations and do not necessarily indicate a particular order or sequence.

### EXAMPLE EMBODIMENTS

An initial overview of technology embodiments is provided below and then specific technology embodiments are described in further detail later. This initial summary is intended to aid readers in understanding the technology more quickly but is not intended to identify key features or essential features of the technology nor is it intended to limit the scope of the claimed subject matter.

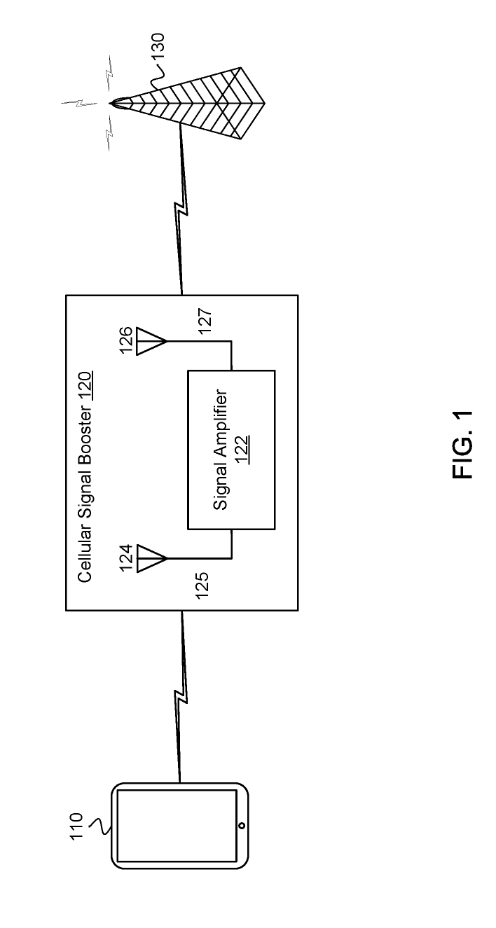

FIG. 1 illustrates an exemplary signal booster 120 in communication with a wireless device 110 and a base station 130. The signal booster 120 can be referred to as a repeater. A repeater can be an electronic device used to amplify (or boost) signals. The signal booster 120 (also referred to as a cellular signal amplifier) can improve the quality of wireless communication by amplifying, filtering, and/or applying other processing techniques via a signal amplifier 122 to uplink signals communicated from the wireless device 110 to the base station 130 and/or downlink signals communicated from the base station 130 to the wireless device 110. In other words, the signal booster 120 can amplify or boost uplink signals and/or downlink signals bi-directionally. In one example, the signal booster 120 can be at a fixed location, such as in a home or office. Alternatively, the signal booster 120 can be attached to a mobile object, such as a vehicle or a wireless device 110.

In one configuration, the signal booster 120 can include an integrated device antenna 124 (e.g., an inside antenna or a coupling antenna) and an integrated node antenna 126 (e.g., an outside antenna). The integrated node antenna 126 can receive the downlink signal from the base station 130. The downlink signal can be provided to the signal amplifier 122 via a second coaxial cable 127 or other type of radio frequency connection operable to communicate radio frequency signals. The signal amplifier 122 can include one or more cellular signal amplifiers for amplification and filtering. The downlink signal that has been amplified and filtered can be provided to the integrated device antenna 124 via a first coaxial cable 125 or other type of radio frequency connection operable to communicate radio frequency signals. The integrated device antenna 124 can wirelessly communicate the downlink signal that has been amplified and filtered to the wireless device 110.

Similarly, the integrated device antenna 124 can receive an uplink signal from the wireless device 110. The uplink signal can be provided to the signal amplifier 122 via the first coaxial cable 125 or other type of radio frequency connection operable to communicate radio frequency signals. The signal amplifier 122 can include one or more cellular signal amplifiers for amplification and filtering. The uplink signal that has been amplified and filtered can be provided to the integrated node antenna 126 via the second coaxial cable 127 or other type of radio frequency connection operable to communicate radio frequency signals. The integrated node antenna 126 can communicate the uplink signal that has been amplified and filtered to the base station 130.

In one example, the signal booster 120 can filter the uplink and downlink signals using any suitable analog or digital filtering technology including, but not limited to, surface acoustic wave (SAW) filters, bulk acoustic wave (BAW) filters, film bulk acoustic resonator (FBAR) filters, ceramic filters, waveguide filters or low-temperature co-fired ceramic (LTCC) filters.

In one example, the signal booster 120 can send uplink signals to a node and/or receive downlink signals from the node. The node can comprise a wireless wide area network (WWAN) access point (AP), a base station (BS), an evolved Node B (eNB), a baseband unit (BBU), a remote radio head (RRH), a remote radio equipment (RRE), a relay station (RS), a radio equipment (RE), a remote radio unit (RRU), a central processing module (CPM), or another type of WWAN access point.

In one configuration, the signal booster 120 used to amplify the uplink and/or a downlink signal is a handheld booster. The handheld booster can be implemented in a sleeve of the wireless device 110. The wireless device sleeve can be attached to the wireless device 110, but can be removed as needed. In this configuration, the signal booster 120 can automatically power down or cease amplification when the wireless device 110 approaches a particular base station. In other words, the signal booster 120 can determine to stop performing signal amplification when the quality of uplink and/or downlink signals is above a defined threshold based on a location of the wireless device 110 in relation to the base station 130.

In one example, the signal booster 120 can include a battery to provide power to various components, such as the signal amplifier 122, the integrated device antenna 124 and the integrated node antenna 126. The battery can also power the wireless device 110 (e.g., phone or tablet). Alternatively, the signal booster 120 can receive power from the wireless device 110.

In one configuration, the signal booster 120 can be a Federal Communications Commission (FCC)-compatible consumer signal booster. As a non-limiting example, the signal booster 120 can be compatible with FCC Part 20 or 47 Code of Federal Regulations (C.F.R.) Part 20.21 (Mar. 21, 2013). In addition, the signal booster 120 can operate on the frequencies used for the provision of subscriber-based services under parts 22 (Cellular), 24 (Broadband PCS), 27 (AWS-1, 700 MHz Lower A-E Blocks, and 700 MHz Upper C Block), and 90 (Specialized Mobile Radio) of 47 C.F.R. The signal booster 120 can be configured to automatically self-monitor its operation to ensure compliance with applicable noise and gain limits. The signal booster 120 can either self-correct or shut down automatically if the signal booster's operations violate the regulations defined in FCC Part 20.21.

In one configuration, the signal booster 120 can improve the wireless connection between the wireless device 110 and the base station 130 (e.g., cell tower) or another type of wireless wide area network (WWAN) access point (AP). The signal booster 120 can boost signals for cellular standards, such as the Third Generation Partnership Project (3GPP) Long Term Evolution (LTE) Release 8, 9, 10, 11, 12, or 13 standards or Institute of Electronics and Electrical Engineers (IEEE) 802.16. In one configuration, the signal booster 120 can boost signals for 3GPP LTE Release 13.0.0 (March 2016) or other desired releases. The signal booster 120 can boost signals from the 3GPP Technical Specification 36.101 (Release 12 Jun. 2015) bands or LTE frequency bands. For example, the signal booster 120 can boost signals from the LTE frequency bands: 2, 4, 5, 12, 13, 17, and 25. In addition, the signal booster 120 can boost selected frequency bands based on the country or region in which the signal booster is used, including any of bands 1-70 or other bands, as disclosed in ETSI TS136 104 V13.5.0 (October 2016).

The number of LTE frequency bands and the level of signal improvement can vary based on a particular wireless device, cellular node, or location. Additional domestic and international frequencies can also be included to offer increased functionality. Selected models of the signal booster 120 can be configured to operate with selected frequency bands based on the location of use. In another example, the signal booster 120 can automatically sense from the wireless device 110 or base station 130 (or GPS, etc.) which frequencies are used, which can be a benefit for international travelers.

In one example, the integrated device antenna 124 and the integrated node antenna 126 can be comprised of a single antenna, an antenna array, or have a telescoping form-factor. In another example, the integrated device antenna 124 and the integrated node antenna 126 can be a microchip antenna. An example of a microchip antenna is AMMAL001. In yet another example, the integrated device antenna 124 and the integrated node antenna 126 can be a printed circuit board (PCB) antenna. An example of a PCB antenna is TE 2118310-1.

In one example, the integrated device antenna 124 can receive uplink (UL) signals from the wireless device 100 and transmit DL signals to the wireless device 100 using a single antenna. Alternatively, the integrated device antenna 124 can receive UL signals from the wireless device 100 using a dedicated UL antenna, and the integrated device antenna 124 can transmit DL signals to the wireless device 100 using a dedicated DL antenna.

In one example, the integrated device antenna 124 can communicate with the wireless device 110 using near field communication. Alternatively, the integrated device antenna 124 can communicate with the wireless device 110 using far field communication.

In one example, the integrated node antenna 126 can receive downlink (DL) signals from the base station 130 and transmit uplink (UL) signals to the base station 130 via a single antenna. Alternatively, the integrated node antenna 126 can receive DL signals from the base station 130 using a dedicated DL antenna, and the integrated node antenna 126 can transmit UL signals to the base station 130 using a dedicated UL antenna.

In one configuration, multiple signal boosters can be used to amplify UL and DL signals. For example, a first signal booster can be used to amplify UL signals and a second signal booster can be used to amplify DL signals. In addition, different signal boosters can be used to amplify different frequency ranges.

In one configuration, the signal booster 120 can be configured to identify when the wireless device 110 receives a relatively strong downlink signal. An example of a strong downlink signal can be a downlink signal with a signal strength greater than approximately −80 dBm. The signal booster 120 can be configured to automatically turn off selected features, such as amplification, to conserve battery life. When the signal booster 120 senses that the wireless device 110 is receiving a relatively weak downlink signal, the integrated booster can be configured to provide amplification of the downlink signal. An example of a weak downlink signal can be a downlink signal with a signal strength less than −80 dBm.

In one example, the signal booster 120 can also include one or more of: a waterproof casing, a shock absorbent casing, a flip-cover, a wallet, or extra memory storage for the wireless device. In one example, extra memory storage can be achieved with a direct connection between the signal booster 120 and the wireless device 110. In another example, Near-Field Communications (NFC), Bluetooth v4.0, Bluetooth Low Energy, Bluetooth v4.1, Bluetooth v4.2, Bluetooth 5, Ultra High Frequency (UHF), 3GPP LTE, Institute of Electronics and Electrical Engineers (IEEE) 802.11a, IEEE 802.11b, IEEE 802.11g, IEEE 802.11n, IEEE 802.11ac, or IEEE 802.11ad can be used to couple the signal booster 120 with the wireless device 110 to enable data from the wireless device 110 to be communicated to and stored in the extra memory storage that is integrated in the signal booster 120. Alternatively, a connector can be used to connect the wireless device 110 to the extra memory storage.

In one example, the signal booster 120 can include photovoltaic cells or solar panels as a technique of charging the integrated battery and/or a battery of the wireless device 110. In another example, the signal booster 120 can be configured to communicate directly with other wireless devices with signal boosters. In one example, the integrated node antenna 126 can communicate over Very High Frequency (VHF) communications directly with integrated node antennas of other signal boosters. The signal booster 120 can be configured to communicate with the wireless device 110 through a direct connection, Near-Field Communications (NFC), Bluetooth v4.0, Bluetooth Low Energy, Bluetooth v4.1, Bluetooth v4.2, Ultra High Frequency (UHF), 3GPP LTE, Institute of Electronics and Electrical Engineers (IEEE) 802.11a, IEEE 802.11b, IEEE 802.11g, IEEE 802.11n, IEEE 802.11ac, IEEE 802.11ad, a TV White Space Band (TVWS), or any other industrial, scientific and medical (ISM) radio band. Examples of such ISM bands include 2.4 GHz, 3.6 GHz, 4.9 GHz, 5 GHz, or 5.9 GHz. This configuration can allow data to pass at high rates between multiple wireless devices with signal boosters. This configuration can also allow users to send text messages, initiate phone calls, and engage in video communications between wireless devices with signal boosters. In one example, the integrated node antenna 126 can be configured to couple to the wireless device 110. In other words, communications between the integrated node antenna 126 and the wireless device 110 can bypass the integrated booster.

In another example, a separate VHF node antenna can be configured to communicate over VHF communications directly with separate VHF node antennas of other signal boosters. This configuration can allow the integrated node antenna 126 to be used for simultaneous cellular communications. The separate VHF node antenna can be configured to communicate with the wireless device 110 through a direct connection, Near-Field Communications (NFC), Bluetooth v4.0, Bluetooth Low Energy, Bluetooth v4.1, Bluetooth v4.2, Ultra High Frequency (UHF), 3GPP LTE, Institute of Electronics and Electrical Engineers (IEEE) 802.11a, IEEE 802.11b, IEEE 802.11g, IEEE 802.11n, IEEE 802.11ac, IEEE 802.11ad, a TV White Space Band (TVWS), or any other industrial, scientific and medical (ISM) radio band.

In one configuration, the signal booster 120 can be configured for satellite communication. In one example, the integrated node antenna 126 can be configured to act as a satellite communication antenna. In another example, a separate node antenna can be used for satellite communications. The signal booster 120 can extend the range of coverage of the wireless device 110 configured for satellite communication. The integrated node antenna 126 can receive downlink signals from satellite communications for the wireless device 110. The signal booster 120 can filter and amplify the downlink signals from the satellite communication. In another example, during satellite communications, the wireless device 110 can be configured to couple to the signal booster 120 via a direct connection or an ISM radio band. Examples of such ISM bands include 2.4 GHz, 3.6 GHz, 4.9 GHz, 5 GHz, or 5.9 GHz.

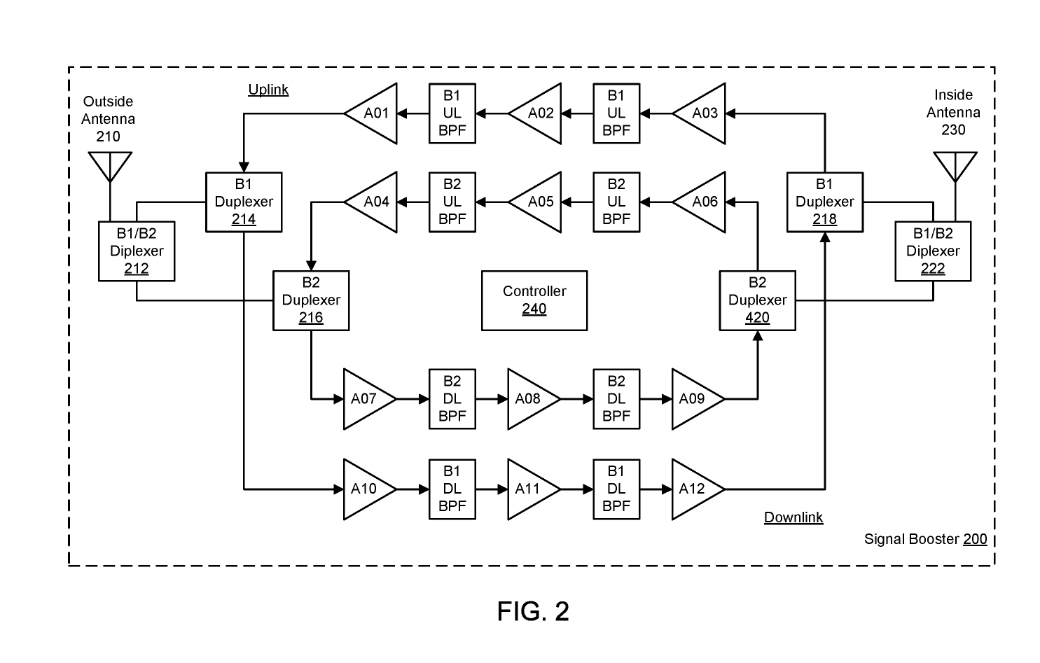

FIG. 2 illustrates an exemplary bi-directional wireless signal booster 200 configured to amplify uplink (UL) and downlink (DL) signals using a separate signal path for each UL frequency band and DL frequency band and a controller 240. The bi-directional wireless signal booster 200 can be integrated with a GPS module in a signal booster. An outside antenna 210, or an integrated node antenna, can receive a downlink signal. For example, the downlink signal can be received from a base station (not shown). The downlink signal can be provided to a first B1/B2 diplexer 212, wherein B1 represents a first frequency band and B2 represents a second frequency band. The first B1/B2 diplexer 212 can create a B1 downlink signal path and a B2 downlink signal path. Therefore, a downlink signal that is associated with B1 can travel along the B1 downlink signal path to a first B1 duplexer 214, or a downlink signal that is associated with B2 can travel along the B2 downlink signal path to a first B2 duplexer 216. After passing the first B1 duplexer 214, the downlink signal can travel through a series of amplifiers (e.g., A10, A11 and A12) and downlink band pass filters (BPF) to a second B1 duplexer 218. Alternatively, after passing the first B2 duplexer 216, the downlink can travel through a series of amplifiers (e.g., A07, A08 and A09) and downlink band pass filters (BFF) to a second B2 duplexer 220. At this point, the downlink signal (B1 or B2) has been amplified and filtered in accordance with the type of amplifiers and BPFs included in the bi-directional wireless signal booster 200. The downlink signals from the second B1 duplexer 218 or the second B2 duplexer 220, respectively, can be provided to a second B1/B2 diplexer 222. The second B1/B2 diplexer 222 can provide an amplified downlink signal to an inside antenna 230, or an integrated device antenna. The inside antenna 230 can communicate the amplified downlink signal to a wireless device (not shown), such as a mobile phone.

In one example, the inside antenna 230 can receive an uplink (UL) signal from the wireless device. The uplink signal can be provided to the second B1/B2 diplexer 222. The second B1/B2 diplexer 222 can create a B1 uplink signal path and a B2 uplink signal path. Therefore, an uplink signal that is associated with B1 can travel along the B1 uplink signal path to the second B1 duplexer 218, or an uplink signal that is associated with B2 can travel along the B2 uplink signal path to the second B2 duplexer 222. After passing the second B1 duplexer 218, the uplink signal can travel through a series of amplifiers (e.g., A01, A02 and A03) and uplink band pass filters (BPF) to the first B1 duplexer 214. Alternatively, after passing the second B2 duplexer 220, the uplink signal can travel through a series of amplifiers (e.g., A04, A05 and A06) and uplink band pass filters (BPF) to the first B2 duplexer 216. At this point, the uplink signal (B1 or B2) has been amplified and filtered in accordance with the type of amplifiers and BFFs included in the bi-directional wireless signal booster 200. The uplink signals from the first B1 duplexer 214 or the first B2 duplexer 216, respectively, can be provided to the first B1/B2 diplexer 12. The first B1/B2 diplexer 212 can provide an amplified uplink signal to the outside antenna 210. The outside antenna can communicate the amplified uplink signal to the base station.

In one example, the bi-directional wireless signal booster 200 can be a 6-band booster. In other words, the bi-directional wireless signal booster 200 can perform amplification and filtering for downlink and uplink signals having a frequency in bands B1, B2, B3 B4, B5 and/or B6.

In one example, the bi-directional wireless signal booster 200 can use the duplexers to separate the uplink and downlink frequency bands, which are then amplified and filtered separately. A multiple-band cellular signal booster can typically have dedicated radio frequency (RF) amplifiers (gain blocks), RF detectors, variable RF attenuators and RF filters for each uplink and downlink band.

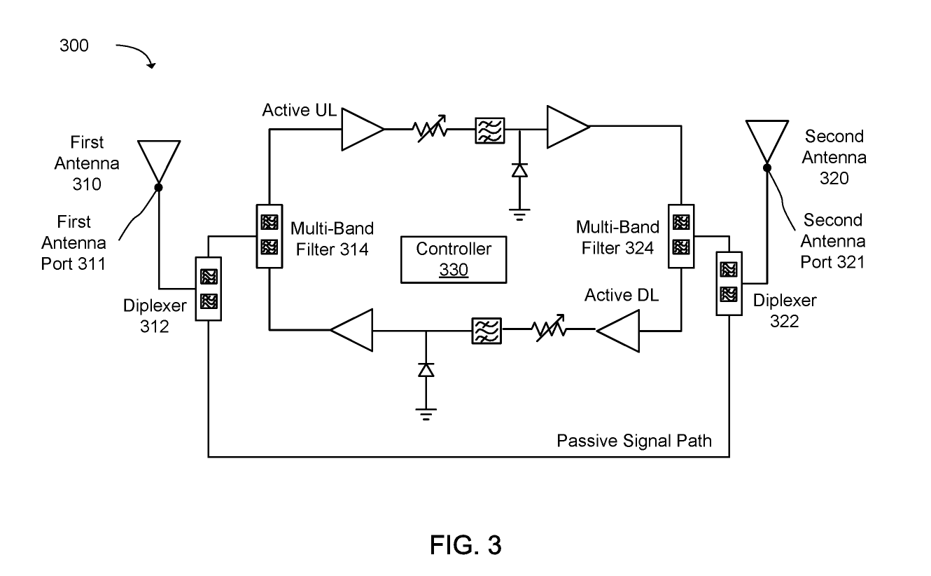

FIG. 3 illustrates an exemplary signal booster 300 (or repeater) with one or more active signal paths and an adjacent passive signal path. The active signal paths can filter and amplify signals in one or more bands. The passive signal path can to passively pass through signals in one or more bands without amplification of the signals. The passive signal path can be adjacent to the active signal paths in the signal booster 300. Signals in certain bands can be amplified, while signals in other bands can be passively passed through without amplification. The active signal paths and the passive signal path can operate simultaneously in the signal booster 300.

In one example, the signal booster 300 can include a first antenna 310 (or inside antenna), which can be coupled to a first antenna port 311. The first antenna 310 can be communicatively coupled to a first diplexer 312. The first diplexer 312 can be communicatively coupled to a first multi-band filter 314. The first multi-band filter 314 can include a duplexer, triplexer, quadplexer, etc. In one example, the signal booster 300 can include a second antenna 320 (or outside antenna), which can be coupled to a second antenna port 321. The second antenna 320 can be communicatively coupled to a second diplexer 322. The second diplexer 322 can be communicatively coupled to a second multi-band filter 324. The second multi-band filter 324 can include a duplexer, triplexer, quadplexer, etc.

In one example, the signal booster 300 can include one or more active signal paths communicatively coupled between the first multi-band filter 314 and the second multi-band filter 324. For example, the one or more active signal paths can include an active uplink signal path and/or an active downlink signal path. The active uplink signal path can include one or more amplifiers (e.g., low-noise amplifiers, power amplifiers) and one or more filters. Similarly, the active downlink signal path can include one or more amplifiers (e.g., low-noise amplifiers, power amplifiers) and one or more filters. In addition, the active uplink signal path and the active downlink signal path can each include detectors for detecting power levels of the signals.

In one example, the signal booster 300 can include the passive signal path communicatively coupled between the first antenna 310 and the second antenna 320. More specifically, the passive signal path can be communicatively coupled between the first diplexer 312 and the second diplexer 322. The passive signal path can be adjacent to the active signal paths (e.g., the active uplink signal path and the active downlink signal path). In one example, the passive signal path can passively pass through signals in one or more bands without amplification of the signals. In contrast to the active signal paths, the passive signal path may not include amplifiers and filters. In addition, the passive signal path can passively pass through signals in an uplink or a downlink.

In one configuration, the first antenna 310 can receive an uplink signal from a mobile device (not shown). The first antenna 310 can pass the uplink signal to the first diplexer 312. Depending on a frequency of the uplink signal, the first diplexer 312 can either pass the uplink signal to the first multi-band filter 314, or the uplink signal can be directed to the passive signal path. In other words, signals in certain bands can be directed to the first multi-band filter 314, whereas signals in other bands can be directed to the passive signal path. When the uplink signal is passed to the first multi-band filter 314, the uplink signal can be directed to the active uplink signal path by the first multi-band filter 314. The active uplink signal path can amplify and filter the uplink signal using one or more amplifiers and one or more filters, respectively. The uplink signal (which has been amplified and filtered) can be directed to the second multi-band filter 324. The second multi-band filter 324 can pass the uplink signal (which has been amplified and filtered) to the second diplexer 322. The second diplexer 322 can direct the uplink signal (which has been amplified and filtered) to the second antenna 320 for transmission to a base station (not shown). Alternatively, when the uplink signal is directed to the passive signal path, the uplink signal can pass through without amplification and filtering of the uplink signal. The uplink signal can be provided to the second diplexer 322. The second diplexer 322 can direct the uplink signal (which has not been amplified and filtered) to the second antenna 320 for transmission to the base station.

In one configuration, the second antenna 320 can receive a downlink signal from the base station. The second antenna 320 can pass the downlink signal to the second diplexer 322. Depending on a frequency of the downlink signal, the second diplexer 322 can either pass the downlink signal to the second multi-band filter 324, or the downlink signal can be directed to the passive signal path. In other words, signals in certain bands can be directed to the second multi-band filter 324, whereas signals in other bands can be directed to the passive signal path. When the downlink signal is passed to the second multi-band filter 324, the downlink signal can be directed to the active downlink signal path by the second multi-band filter 324. The active downlink signal path can amplify and filter the downlink signal using one or more amplifiers and one or more filters, respectively. The downlink signal (which has been amplified and filtered) can be directed to the first multi-band filter 314. The first multi-band filter 314 can pass the downlink signal (which has been amplified and filtered) to the first diplexer 312. The first diplexer 312 can direct the downlink signal (which has been amplified and filtered) to the first antenna 310 for transmission to the mobile device. Alternatively, when the downlink signal is directed to the passive signal path, the downlink signal can pass through without amplification and filtering of the downlink signal. The downlink signal can be provided to the first diplexer 312. The first diplexer 312 can direct the downlink signal (which has not been amplified and filtered) to the first antenna 310 for transmission to the mobile device.

As a non-limiting example, the first antenna 310 can receive an uplink signal in band 5 (B5). Depending on which bands in the signal booster 300 are active and which bands in the signal booster 300 are passive, the first diplexer 312 can pass the uplink signal in B5 to the first multi-band filter 314 or to the passive signal path. When the uplink signal in B5 is passed to the first multi-band filter 314, the uplink signal in B5 can be amplified and filtered, and then provided to the second antenna 320 via the second multi-band filter 324 and the second diplexer 322. When the uplink signal in B5 is passed to the passive signal path, the uplink signal in B5 can be provided to the second antenna 320 via the second diplexer 322 without amplification.

As another non-limiting example, the second antenna 320 can receive a downlink signal in band 4 (B4). Depending on which bands in the signal booster 300 are active and which bands in the signal booster 300 are passive, the second diplexer 322 can pass the downlink signal in B4 to the second multi-band filter 324 or to the passive signal path. When the downlink signal in B4 is passed to the second multi-band filter 324, the downlink signal in B4 can be amplified and filtered, and then provided to the first antenna 310 via the first multi-band filter 314 and the first diplexer 312. When the downlink signal in B4 is passed to the passive signal path, the downlink signal in B4 can be provided to the first antenna 310 via the first diplexer 312 without amplification.

In one example, the active signal paths can filter and amplify signals in one or more high frequency bands. The high frequency bands can include, but are not limited to, band 4 (B4) or band 25 (B25). In the uplink, B4 can correspond to a frequency range of 1710 megahertz (MHz) to 1755 MHz, and B25 can correspond to a frequency range of 1850 MHz to 1915 MHz. In the downlink, B4 can correspond to a frequency range of 2110 MHz to 2155 MHz, and B25 can correspond to a frequency range of 1930 MHz to 1995 MHz.

In one example, the passive signal path can passively pass through signals in one or more low frequency bands. The low frequency bands can include, but are not limited to, band 5 (B5), band 12 (B12), band 13 (B13) or a 600 megahertz (MHz) band. In the uplink, B5 can correspond to a frequency range of 824 MHz to 849 MHz, B12 can correspond to a frequency range of 699 MHz to 716 MHz, and B13 can correspond to a frequency range of 777 MHz to 787 MHz. In the downlink, B5 can correspond to a frequency range of 869 MHz to 894 MHz, B12 can correspond to a frequency range of 729 MHz to 746 MHz, and B13 can correspond to a frequency range of 746 MHz to 756 MHz.

In one configuration, the signal booster 300 can include a defined number of active bands and a defined number of passive bands. In other words, signals that are included in one of the active bands can be passed through an active signal path (uplink or downlink) for amplification and filtering of the signals. On the other hand, signals that are included in one of the passive bands can be passed through the passive signal path (uplink or downlink), which does not involve amplification and filtering of the signals. As a non-limiting example, the signal booster 300 can include four active bands and two passive bands. The four active bands can correspond to high frequency bands, whereas the two passive bands can correspond to low frequency bands, or vice versa.

In previous solutions, a signal booster can amplify each of the bands that are supported by the signal booster. For example, in previous solutions, a five-band booster can amplify signals in each of the five bands. However, there can be situations in which each band does not need to be amplified. For example, in certain situations, it can be advantageous to amplify certain bands (e.g., high frequency bands) but unnecessary to amplify other bands (e.g., low frequency bands). For example, since low frequency bands can propagate favorably, it may not be necessary to always amplify signals in low frequency bands. Rather, it can be more efficient to simply pass through these signals in the low frequency bands. Therefore, in the present technology, the signal booster 300 can amplify signals in certain bands (which can be referred to as active bands), while passively passing through signals in other bands (which can be referred to as passive bands).

In one example, the passive signal path can passively pass through global position system (GPS) signals. The GPS signals can be passively passed through the signal booster 300 via the passive signal path since amplification and re-radiation of GPS signals are generally not allowed in the signal booster 300.

In one configuration, filtering isolation in the first and second diplexers 312, 322 can prevent signals on the active signal paths from feeding back through the passive signal path, which can undesirably result in an oscillation or feedback. In one example, additional filtering can be added on the passive signal path to reduce a likelihood of an oscillation or feedback in the signal booster 300.

In one example, the signal booster 300 can employ the first antenna port 311 and the second antenna port 321, which can be shared by the active signal paths and the passive signal path. In other words, both the active signal paths and the passive signal path can be communicatively coupled to the first antenna 310 and the second antenna 320. In an alternative example, the active signal paths and the passive signal path can utilize separate antenna port pairs, respectively, such that a first pair of antennas can be utilized for the active signal paths and a second pair of antennas can be utilized for the passive signal path.

In one example, the signal booster 300 can include a controller 330 operable to perform network protection for the one or more active signal paths communicatively coupled between the first multi-band filter 314 and the second multi-band filter 324. The controller 330 may not perform network protection for the passive signal path. The controller 330 can perform the network protection for the active signal paths in order to protect a cellular network from overload or noise floor increase. The controller can perform network protection by adjusting a gain or noise power for each band in the uplink transmission paths based on data from each band in the downlink transmission paths. The data from each band in the downlink transmission paths can include a booster station coupling loss (BSCL) or a received signal strength indication (RSSI). The controller can perform network protection in accordance with the Federal Communications Commission (FCC) Consumer Booster Rules, which necessitate that uplink signal paths and downlink signal paths are to work together for network protection.

In one example, the first diplexer 312 and the first multi-band filter 314 can be combined to form a single component in order to reduce complexity and/or cost. Similarly, the second diplexer 322 and the second multi-band filter 324 can be combined to form a single component in order to reduce complexity and/or cost.

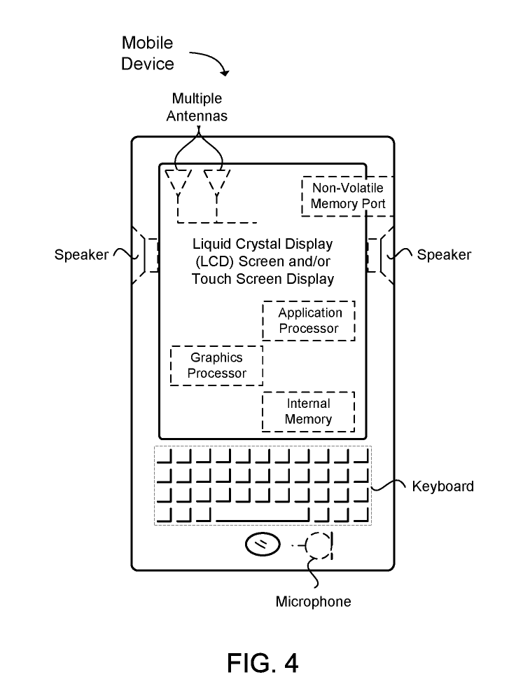

FIG. 4 provides an example illustration of the wireless device, such as a user equipment (UE), a mobile station (MS), a mobile communication device, a tablet, a handset, a wireless transceiver coupled to a processor, or other type of wireless device. The wireless device can include one or more antennas configured to communicate with a node or transmission station, such as an access point (AP), a base station (BS), an evolved Node B (eNB), a baseband unit (BBU), a remote radio head (RRH), a remote radio equipment (RRE), a relay station (RS), a radio equipment (RE), a remote radio unit (RRU), a central processing module (CPM), or other type of wireless wide area network (WWAN) access point. The wireless device can communicate using separate antennas for each wireless communication standard or shared antennas for multiple wireless communication standards. The wireless device can communicate in a wireless local area network (WLAN), a wireless personal area network (WPAN), and/or a WWAN.

FIG. 4 also provides an illustration of a microphone and one or more speakers that can be used for audio input and output from the wireless device. The display screen can be a liquid crystal display (LCD) screen, or other type of display screen such as an organic light emitting diode (OLED) display. The display screen can be configured as a touch screen. The touch screen can use capacitive, resistive, or another type of touch screen technology. An application processor and a graphics processor can be coupled to internal memory to provide processing and display capabilities. A non-volatile memory port can also be used to provide data input/output options to a user. The non-volatile memory port can also be used to expand the memory capabilities of the wireless device. A keyboard can be with the wireless device or wirelessly connected to the wireless device to provide additional user input. A virtual keyboard can also be provided using the touch screen.

### EXAMPLES

The following examples pertain to specific technology embodiments and point out specific features, elements, or actions that can be used or otherwise combined in achieving such embodiments.

Example 1 includes a repeater, comprising: a first antenna port; a second antenna port; a first multi-band filter communicatively coupled to the first antenna port; a second multi-band filter communicatively coupled to the second antenna port; one or more active signal paths communicatively coupled between the first multi-band filter and the second multi-band filter, wherein the one or more active signal paths are configured to filter and amplify signals in one or more bands; and a passive signal path communicatively coupled between the first antenna port and the second antenna port and adjacent to the one or more active signal paths, wherein the passive signal path is configured to passively pass through signals in one or more bands without amplification of the signals.

Example 2 includes the repeater of Example 1, further comprising: a first diplexer communicatively coupled between the first antenna port and the first multi-band filter; and a second diplexer communicatively coupled between the second antenna port and the second multi-band filter.

Example 3 includes the repeater of any of Examples 1 to 2, wherein the one or more active signal paths include at least one of: one or more uplink signal paths or one or more downlink signal paths.

Example 4 includes the repeater of any of Examples 1 to 3, wherein the passive signal path is configured to passively pass through signals in at least one of an uplink or a downlink.

Example 5 includes the repeater of any of Examples 1 to 4, wherein the passive signal path is configured to passively pass through signals in one or more low frequency bands, wherein the low frequency bands include band 5 (B5), band 12 (B12), band 13 (B13) or a 600 megahertz (MHz) band.

Example 6 includes the repeater of any of Examples 1 to 5, wherein the one or more active signal paths are configured to filter and amplify signals in one or more high frequency bands, wherein the high frequency bands include band 4 (B4) or band 25 (B25).

Example 7 includes the repeater of any of Examples 1 to 6, further comprising a controller operable to perform network protection for the one or more active signal paths communicatively coupled between the first multi-band filter and the second multi-band filter.

Example 8 includes the repeater of any of Examples 1 to 7, wherein the passive signal path is configured to passively pass through one or more of: global position system (GPS) signals, global navigation satellite system (GLONASS) signals or Galileo satellite navigation signals.

Example 9 includes a signal booster, comprising: one or more active signal paths configured to filter and amplify signals in one or more bands; and a passive signal path adjacent to the one or more active signal paths, wherein the passive signal path is configured to passively pass through signals in one or more bands without amplification of the signals.

Example 10 includes the signal booster of Example 9, further comprising: a first antenna port; a second antenna port; a first multi-band filter communicatively coupled to the first antenna port; and a second multi-band filter communicatively coupled to the second antenna port.

Example 11 includes the signal booster of any of Examples 9 to 10, wherein: the one or more active signal paths are communicatively coupled between the first multi-band filter and the second multi-band filter; and the passive signal path is communicatively coupled between the first antenna port and the second antenna port.

Example 12 includes the signal booster of any of Examples 9 to 11, further comprising: a first diplexer communicatively coupled between the first antenna port and the first multi-band filter; and a second diplexer communicatively coupled between the second antenna port and the second multi-band filter.

Example 13 includes the signal booster of any of Examples 9 to 12, wherein the one or more active signal paths include at least one of: one or more uplink signal paths or one or more downlink signal paths.

Example 14 includes the signal booster of any of Examples 9 to 13, wherein the passive signal path is configured to passively pass through signals in an uplink or a downlink.

Example 15 includes the signal booster of any of Examples 9 to 14, wherein the passive signal path is configured to passively pass through signals in one or more low frequency bands, wherein the low frequency bands include band 5 (B5), band 12 (B12), band 13 (B13) or a 600 megahertz (MHz) band.

Example 16 includes the signal booster of any of Examples 9 to 15, wherein the one or more active signal paths are configured to filter and amplify signals in one or more high frequency bands, wherein the high frequency bands include band 4 (B4) or band 25 (B25).

Example 17 includes the signal booster of any of Examples 9 to 16, further comprising a controller operable to perform network protection for the one or more active signal paths.

Example 18 includes the signal booster of any of Examples 9 to 17, wherein the passive signal path is configured to passively pass through one or more of: global position system (GPS) signals, global navigation satellite system (GLONASS) signals or Galileo satellite navigation signals.

Example 19 includes the signal booster of any of Examples 9 to 18, wherein the one or more active signal paths include one or more detectors for detecting power levels of the signals.

Example 20 includes a repeater, comprising: a first diplexer; a second diplexer; a first multi-band filter communicatively coupled to the first diplexer; a second multi-band filter communicatively coupled to the second diplexer; one or more active signal paths communicatively coupled between the first multi-band filter and the second multi-band filter, wherein the one or more active signal paths are configured to filter and amplify signals in one or more bands; and a passive signal path communicatively coupled between the first diplexer and the second diplexer and adjacent to the one or more active signal paths, wherein the passive signal path is configured to passively pass through signals in one or more bands without amplification of the signals.

Example 21 includes the repeater of Example 20, further comprising: a first antenna communicatively coupled to the first diplexer; and a second antenna communicatively coupled to the second diplexer.

Example 22 includes the repeater of any of Examples 20 to 21, wherein: the one or more active signal paths include at least one of: one or more uplink signal paths or one or more downlink signal paths; and the passive signal path is configured to passively pass through signals in an uplink or a downlink.

Example 23 includes the repeater of any of Examples 20 to 22, wherein: the passive signal path is configured to passively pass through signals in one or more low frequency bands, wherein the low frequency bands include band 5 (B5), band 12 (B12), band 13 (B13) or a 600 megahertz (MHz) band; and the one or more active signal paths are configured to filter and amplify signals in one or more high frequency bands, wherein the high frequency bands include band 4 (B4) or band 25 (B25).

Example 24 includes the repeater of any of Examples 20 to 23, wherein the passive signal path is configured to passively pass through one or more of: global position system (GPS) signals, global navigation satellite system (GLONASS) signals or Galileo satellite navigation signals.

Various techniques, or certain aspects or portions thereof, can take the form of program code (i.e., instructions) embodied in tangible media, such as floppy diskettes, compact disc-read-only memory (CD-ROMs), hard drives, non-transitory computer readable storage medium, or any other machine-readable storage medium wherein, when the program code is loaded into and executed by a machine, such as a computer, the machine becomes an apparatus for practicing the various techniques. Circuitry can include hardware, firmware, program code, executable code, computer instructions, and/or software. A non-transitory computer readable storage medium can be a computer readable storage medium that does not include signal. In the case of program code execution on programmable computers, the computing device can include a processor, a storage medium readable by the processor (including volatile and non-volatile memory and/or storage elements), at least one input device, and at least one output device. The volatile and non-volatile memory and/or storage elements can be a random-access memory (RAM), erasable programmable read only memory (EPROM), flash drive, optical drive, magnetic hard drive, solid state drive, or other medium for storing electronic data. One or more programs that can implement or utilize the various techniques described herein can use an application programming interface (API), reusable controls, and the like. Such programs can be implemented in a high level procedural or object oriented programming language to communicate with a computer system. However, the program(s) can be implemented in assembly or machine language, if desired. In any case, the language can be a compiled or interpreted language, and combined with hardware implementations.

As used herein, the term processor can include general purpose processors, specialized processors such as VLSI, FPGAs, or other types of specialized processors, as well as base band processors used in transceivers to send, receive, and process wireless communications.

It should be understood that many of the functional units described in this specification have been labeled as modules, in order to more particularly emphasize their implementation independence. For example, a module can be implemented as a hardware circuit comprising custom very-large-scale integration (VLSI) circuits or gate arrays, off-the-shelf semiconductors such as logic chips, transistors, or other discrete components. A module can also be implemented in programmable hardware devices such as field programmable gate arrays, programmable array logic, programmable logic devices or the like.

In one example, multiple hardware circuits or multiple processors can be used to implement the functional units described in this specification. For example, a first hardware circuit or a first processor can be used to perform processing operations and a second hardware circuit or a second processor (e.g., a transceiver or a baseband processor) can be used to communicate with other entities. The first hardware circuit and the second hardware circuit can be incorporated into a single hardware circuit, or alternatively, the first hardware circuit and the second hardware circuit can be separate hardware circuits.

Modules can also be implemented in software for execution by various types of processors. An identified module of executable code can, for instance, comprise one or more physical or logical blocks of computer instructions, which can, for instance, be organized as an object, procedure, or function. Nevertheless, the executables of an identified module need not be physically located together, but can comprise disparate instructions stored in different locations which, when joined logically together, comprise the module and achieve the stated purpose for the module.

Indeed, a module of executable code can be a single instruction, or many instructions, and can even be distributed over several different code segments, among different programs, and across several memory devices. Similarly, operational data can be identified and illustrated herein within modules, and can be embodied in any suitable form and organized within any suitable type of data structure. The operational data can be collected as a single data set, or can be distributed over different locations including over different storage devices, and can exist, at least partially, merely as electronic signals on a system or network. The modules can be passive or active, including agents operable to perform desired functions.

Reference throughout this specification to “an example” or “exemplary” means that a particular feature, structure, or characteristic described in connection with the example is included in at least one embodiment of the present invention. Thus, appearances of the phrases “in an example” or the word “exemplary” in various places throughout this specification are not necessarily all referring to the same embodiment.

As used herein, a plurality of items, structural elements, compositional elements, and/or materials can be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention can be referred to herein along with alternatives for the various components thereof. It is understood that such embodiments, examples, and alternatives are not to be construed as defacto equivalents of one another, but are to be considered as separate and autonomous representations of the present invention.

Furthermore, the described features, structures, or characteristics can be combined in any suitable manner in one or more embodiments. In the following description, numerous specific details are provided, such as examples of layouts, distances, network examples, etc., to provide a thorough understanding of embodiments of the invention. One skilled in the relevant art will recognize, however, that the invention can be practiced without one or more of the specific details, or with other methods, components, layouts, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A repeater, comprising:
a first antenna port;
a second antenna port;
a first multi-band filter communicatively coupled to the first antenna port;
a second multi-band filter communicatively coupled to the second antenna port;
one or more active signal paths communicatively coupled between the first multi-band filter and the second multi-band filter, wherein the one or more active signal paths are configured to filter and amplify signals in one or more bands; and
a passive signal path communicatively coupled between the first antenna port and the second antenna port and adjacent to the one or more active signal paths, wherein the passive signal path is configured to passively pass through signals in one or more bands without amplification of the signals.

2. The repeater of claim 1, further comprising:
a first diplexer communicatively coupled between the first antenna port and the first multi-band filter; and
a second diplexer communicatively coupled between the second antenna port and the second multi-band filter.

3. The repeater of claim 1, wherein the one or more active signal paths include at least one of: one or more uplink signal paths or one or more downlink signal paths.

4. The repeater of claim 1, wherein the passive signal path is configured to passively pass through signals in at least one of an uplink or a downlink.

5. The repeater of claim 1, wherein the passive signal path is configured to passively pass through signals in one or more low frequency bands, wherein the low frequency bands include band 5 (B5), band 12 (B12), band 13 (B13) or a 600 megahertz (MHz) band.

6. The repeater of claim 1, wherein the one or more active signal paths are configured to filter and amplify signals in one or more high frequency bands, wherein the high frequency bands include band 4 (B4) or band 25 (B25).

7. The repeater of claim 1, further comprising a controller operable to perform network protection for the one or more active signal paths communicatively coupled between the first multi-band filter and the second multi-band filter.

8. The repeater of claim 1, wherein the passive signal path is configured to passively pass through one or more of: global position system (GPS) signals, global navigation satellite system (GLONASS) signals or Galileo satellite navigation signals.

9. A signal booster, comprising:
one or more active signal paths configured to filter and amplify signals in one or more bands; and
a passive signal path adjacent to the one or more active signal paths, wherein the passive signal path is configured to passively pass through signals in one or more bands without amplification of the signals.

10. The signal booster of claim 9, further comprising:
a first antenna port;
a second antenna port;
a first multi-band filter communicatively coupled to the first antenna port; and
a second multi-band filter communicatively coupled to the second antenna port.

11. The signal booster of claim 10, wherein:
the one or more active signal paths are communicatively coupled between the first multi-band filter and the second multi-band filter; and
the passive signal path is communicatively coupled between the first antenna port and the second antenna port.

12. The signal booster of claim 10, further comprising:
a first diplexer communicatively coupled between the first antenna port and the first multi-band filter; and
a second diplexer communicatively coupled between the second antenna port and the second multi-band filter.

13. The signal booster of claim 9, wherein the one or more active signal paths include at least one of: one or more uplink signal paths or one or more downlink signal paths.

14. The signal booster of claim 9, wherein the passive signal path is configured to passively pass through signals in an uplink or a downlink.

15. The signal booster of claim 9, wherein the passive signal path is configured to passively pass through signals in one or more low frequency bands, wherein the low frequency bands include band 5 (B5), band 12 (B12), band 13 (B13) or a 600 megahertz (MHz) band.

16. The signal booster of claim 9, wherein the one or more active signal paths are configured to filter and amplify signals in one or more high frequency bands, wherein the high frequency bands include band 4 (B4) or band 25 (B25).

17. The signal booster of claim 9, further comprising a controller operable to perform network protection for the one or more active signal paths.

18. The signal booster of claim 9, wherein the passive signal path is configured to passively pass through one or more of: global position system (GPS) signals, global navigation satellite system (GLONASS) signals or Galileo satellite navigation signals.

19. The signal booster of claim 9, wherein the one or more active signal paths include one or more detectors for detecting power levels of the signals.

20. A repeater, comprising:
a first diplexer;
a second diplexer;
a first multi-band filter communicatively coupled to the first diplexer;
a second multi-band filter communicatively coupled to the second diplexer;
one or more active signal paths communicatively coupled between the first multi-band filter and the second multi-band filter, wherein the one or more active signal paths are configured to filter and amplify signals in one or more bands; and
a passive signal path communicatively coupled between the first diplexer and the second diplexer and adjacent to the one or more active signal paths, wherein the passive signal path is configured to passively pass through signals in one or more bands without amplification of the signals.

21. The repeater of claim 20, further comprising:
a first antenna communicatively coupled to the first diplexer; and
a second antenna communicatively coupled to the second diplexer.

22. The repeater of claim 20, wherein:
the one or more active signal paths include at least one of: one or more uplink signal paths or one or more downlink signal paths; and
the passive signal path is configured to passively pass through signals in an uplink or a downlink.

23. The repeater of claim 20, wherein:
the passive signal path is configured to passively pass through signals in one or more low frequency bands, wherein the low frequency bands include band 5 (B5), band 12 (B12), band 13 (B13) or a 600 megahertz (MHz) band; and
the one or more active signal paths are configured to filter and amplify signals in one or more high frequency bands, wherein the high frequency bands include band 4 (B4) or band 25 (B25).

24. The repeater of claim 20, wherein the passive signal path is configured to passively pass through one or more of: global position system (GPS) signals, global navigation satellite system (GLONASS) signals or Galileo satellite navigation signals.
